(19) United States
(12) Patent Application Publication
(10) Pub. No.: US 2013/0035929 A1
(43) Pub. Date: Feb. 7, 2013

(54) INFORMATION PROCESSING APPARATUS AND METHOD

(71) Applicants: Masayuki Okamoto, Kanagawa-ken (JP); Nayuko Watanabe, Kanagawa-ken (JP); Kenta Cho, Kanagawa-ken (JP)

(72) Inventors: Masayuki Okamoto, Kanagawa-ken (JP); Nayuko Watanabe, Kanagawa-ken (JP); Kenta Cho, Kanagawa-ken (JP)

(73) Assignee: KABUSHIKI KAISHA TOSHIBA, Tokyo (JP)

(21) Appl. No.: 13/413,765

(22) Filed: Mar. 7, 2012

(30) Foreign Application Priority Data
Aug. 5, 2011 (JP) 2011-172408

(51) Int. Cl. G06F 17/27

(52) U.S. Cl. 704/9

(57) ABSTRACT

According to one embodiment, an information processing apparatus includes an acquisition unit, an analysis unit, and a generation unit. The acquisition unit is configured to acquire a status of a user while the user is working with a resource. The analysis unit is configured to acquire text information included in the resource by analyzing the resource. The generation unit is configured to generate at least one work label from the status of the user and the text information, and to generate a work history including a part of the text information, to which the work label is assigned.

### CROSS-REFERENCE TO RELATED APPLICATION

This application is based upon and claims the benefit of priority from Japanese Patent Application No. 2011-172408, filed on Aug. 5, 2011; the entire contents of which are incorporated herein by reference.

### FIELD

Embodiments described herein relate generally to an information processing apparatus and a method thereof.

### BACKGROUND

As an information terminal such as a personal computer (PC), an information processing device to generate a history of works (Hereinafter, it is called “work history”) that a user has utilized files such as an electronic document is well known. In the information processing device of conventional technique, by corresponding files utilized by the user and a time when the user has utilized the files, a work history thereof is generated.

As a result, the work history on which a status (such as inputting/reading of text, or the user's moving status) when the user has utilized the files is reflected cannot be generated. Briefly, the work history related to resources for the user to easily understand cannot be generated.

### BRIEF DESCRIPTION OF THE DRAWINGS

FIG. 1 is a block diagram of an information processing apparatus 1 according to the first embodiment.

FIG. 2 is a flow chart of processing of the information processing apparatus 1.

FIG. 3 is a schematic diagram showing correspondence relationship among a user status, text information, and a work label.

FIG. 4 is one example of work history stored in a third storage unit 17.

FIG. 5 is one example of display application to retrieve by a retrieval unit 18.

FIGS. 6A and 6B are examples of work history displayed by a display unit 19.

FIG. 7 is a block diagram of an information processing apparatus 2 according to the second embodiment.

FIG. 8 is a flow chart of generation processing of an assignment rule in the information processing apparatus 2.

FIG. 9 is one example of the assignment rule as a decision tree generated by a rule generation unit 21.

FIG. 10 is another example of the assignment rule.

FIG. 11 is a flow chart of assignment processing of work labels in the information processing apparatus 2.

FIG. 12 is a schematic diagram to explain assignment processing of work labels in the information processing apparatus 2.

FIG. 13 is one example of work history displayed by the display unit 19.

FIGS. 14A and 14B are examples of the work history.

FIG. 15 is one example of a display to register a work label.

FIG. 16 is another example of the work history.

FIG. 17 is one example of a display format of man-hour control.

FIG. 18 is another example of a display format of man-hour control.

### DETAILED DESCRIPTION

According to one embodiment, an information processing apparatus includes an acquisition unit, an analysis unit, and a generation unit. The acquisition unit is configured to acquire a status of a user while the user is working with a resource. The analysis unit is configured to acquire text information included in the resource by analyzing the resource. The generation unit is configured to generate at least one work label from the status of the user and the text information, and to generate a work history including a part of the text information, to which the work label is assigned.

Various embodiments will be described hereinafter with reference to the accompanying drawings.

### The First Embodiment

An information processing apparatus 1 of the first embodiment is used for an information terminal (For example, PC, a smart-phone, or a net-book) able to utilize resources (file and application) of an electronic document.

The information processing apparatus 1 generates a history (work history) of resources worked by a user. In this case, based on a user's status (Hereinafter, it is called “user status”) when the user has worked the resources and contents of the resources including text information, the information processing apparatus 1 assigns “work label” as a tag to retrieve a work history of the resources, to the work history. As a result, the work history for the user to easily understand can be generated.

The user status includes, for example, “moving status”, “proximity status”, “utterance status”, “operation status”, and so on. The moving status in a status related to the user's moving, such as “standstill”, “walking”, “electric train”, “automobile”, and so on. The proximity status is a status related to information (For example, the number of persons, or ID thereof) of other users existing adjacent to the user. The utterance status is a status related to a sound such as existence/non-existence of person's utterance data, a volume and a pitch (loudness of voice), among acoustic data inputted from a microphone. The operation status is a status related to the user's operation for the information processing apparatus 1, such as “inputting of characters”, “editing of files”, “storing of files”, “reading of files”, “reading of Web”, and so on.

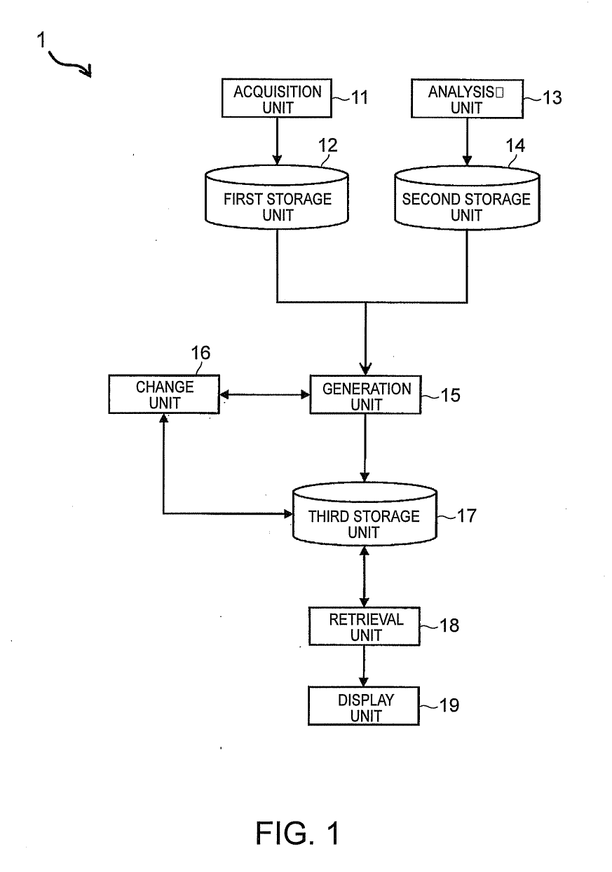

FIG. 1 is a block diagram of the information processing apparatus 1 according to the first embodiment. The information processing apparatus 1 includes an acquisition unit 11, a first storage unit 12, an analysis unit 13, a second storage unit 14, a generation unit, a change unit 16, a third storage unit 17, a retrieval unit 18, and a display unit 19.

The acquisition unit 11 correspondingly acquires a user status, and the date and time of occurrence thereof. The acquisition unit 11 may acquire the moving status by using an acceleration sensor or a GPS sensor. The acquisition unit 11 may acquire the number of terminals adjacent to the user by using a proximity sensor, as the proximity status. The acquisition unit 11 may acquire the utterance status by using a microphone. The acquisition unit 11 writes the user status into the first storage unit 12.

The analysis unit 13 analyzes resources used by a user, and acquires text information included in the resources. The text information is, for example, a name of application worked by the user, a character string included in sentences thereby, or a character string included sentences of Web page read by the user while working.

In this case, the analysis unit 13 acquires the text information with date and time information thereof. The date and time information is information related to date, time or period when work of resources by the user has occurred, such as a start time “10:00” and a completion time “12:00”. The analysis unit 13 writes the text information into the second storage unit 14.

The generation unit 15 extracts a user status from the first storage unit 12. Furthermore, the generation unit 15 extracts text information of which date and time information is same as occurrence date and time of a user status from the second storage unit 14. By using the user status and the text information, the generation unit 15 generates a work label, and a work history to which the work label is assigned. The work label is user's behavior classified into each category (such as “meeting”, “moving”, “dinner party”) which is used as a retrieval tag. The generation unit 15 extracts the work label from the text information by using morphological analysis or build-in rule. The generation unit 15 writes the work history into the third storage unit 17.

When the generation unit 15 assigns a new work label to the work history being presently generated, from work histories already stored in the third storage unit 17, the change unit 16 detects a work history (Hereinafter, it is called “similar work history”) having at least one work label common to the new work label.

If a similar work history is stored in the third storage unit 17, the change unit 16 changes the new work label (assigned to the work history by the generation unit 15) to another work label different from a work label of the similar work history, in order for a user to easily discriminate the another work label for retrieving. Detail processing thereof is explained afterwards. If the similar work history is not stored in the third storage unit 17, the change unit 16 does not change the new work label.

The retrieval unit 18 accepts a retrieval input from the user, and extracts a work history matched with a retrieval condition by referring to the third storage unit 17. The display unit 19 displays the work history extracted by the retrieval unit 18.

The acquisition unit 11, the analysis unit 13, the generation unit 15, the change unit 16, and the retrieval unit 18, may be realized by a central processing unit (CPU) and a memory stored thereby. The first storage unit 12, the second storage unit 14, and the third storage unit 17, may be realized by the memory or an auxiliary storage device.

As mentioned-above, component of the information processing apparatus 1 is already explained.

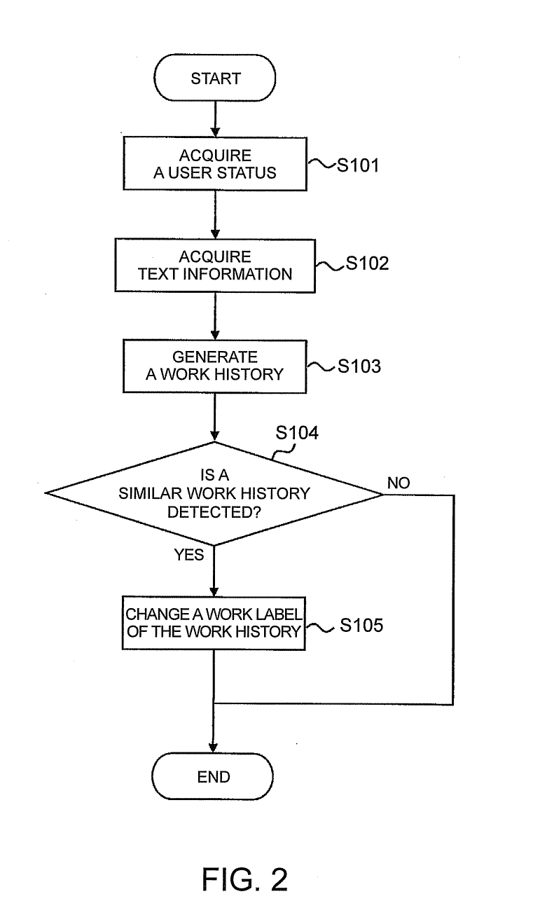

FIG. 2 is a flow chart of generation processing of a work history in the information processing apparatus 1. The acquisition unit 11 correspondingly acquires a user status and the data and time information of occurrence (S101). The acquisition unit 11 writes the user status into the first storage unit 12.

The analysis unit 13 analyzes resources used by a user, and correspondingly acquires text information (included in the resources) and the data and time information (S102). The analysis unit 13 writes the text information into the second storage unit 14.

By using the user status extracted from the first storage unit 12 and the text information (having the date and time information matched with the occurrence of the user status) extracted from the second storage unit 14, the generation unit 15 generates a work label and a work history to which the work label is assigned (S103).

For example, if text information acquired by the analysis unit 13 includes information of 5W1H (who, when, where, which, what, how), such as text information “investigation of A-plan_{—}20100721.ppt” including “contents (invitation of A-plan)” and “date and time (20100721)”, the generation unit 15 segments the text information by using morphological analysis or built-in rule, and extracts text information such as “A-plan” and “investigation” as a work label. The generation unit 15 writes the work history to which the work label is assigned into the third storage unit 17.

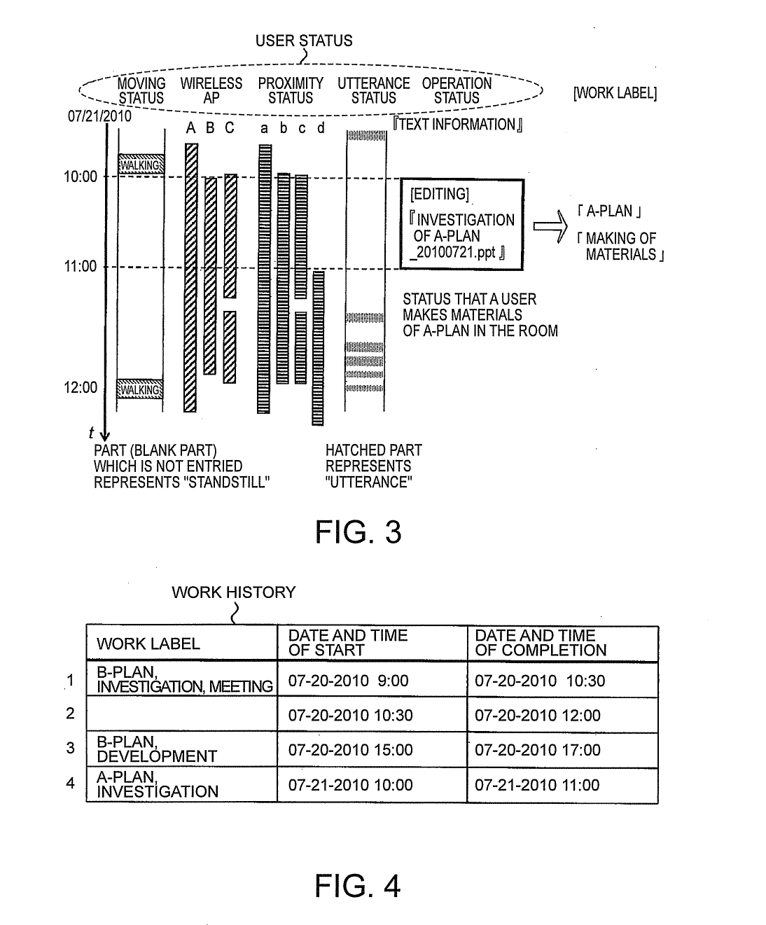

FIG. 3 shows correspondence relationship among the user status, the text information and the work label. In FIG. 3, “work label” represents a work label generated by the generation unit 15, from text information of resources worked by the user at Jul. 21, 2010.

As shown in FIG. 3, the acquisition unit 11 acquires “moving status”, “wireless AP”, “proximity status” and “operation status” as the user status. In “moving status”, a part (blank part) which is not entered with “walking” represents “standstill”. Moreover, “wireless AP” represents an access point of a wireless terminal existing adjacent to the user. In FIG. 3, “A”, “B” and “C” represent each access point, and an oblique line part represents that the access point is operating.

The “proximity status” represents another user's terminal existing adjacent to the user. In FIG. 3, “a”, “b”, “c” and “d” represent other user's terminals, and a horizontal line part represents that each of other user's terminal is operating.

The “utterance status” represents a section having utterance (hatched part in FIG. 3) as “utterance”. Except for this, as “utterance information”, a ratio of a section having “utterance” to a period corresponding to each work label may be used.

The “operation status” represents editing of file “investigation of A-plan_{—}20100721.ppt” in a period “10:00˜11:00 of Jul. 21, 2010”. In this case, text information includes “investigation of A-plan_{—}20100721.ppt”.

The generation unit 15 segments the text information, extracts work labels such as “A-plan” and “investigation”, and generates a work history of this period. FIG. 4 shows one example of the work history. For example, the work history may be the work label, and the data and time (a start time and a completion time) information corresponded thereto. In this example, the generation unit 15 generates a work history “4” in FIG. 4.

When the generation unit 15 assigns a work label to a work history presently generated, the change unit 16 detects another work history similar to the work history by referring to the third storage unit 17 (S104).

When the similar work history is detected (Yes at S104), the change unit 16 changers the work label (assigned to the work history presently generated by the generation unit 15) to another work label different from that of the similar work history (S105). For example, a work label common to that of the similar work history may be deleted. Alternatively, a work label different from that of the similar work history may be located at the head position among work labels, or a work label different from that of the similar work history may be emphasized while being displayed hereafter. In the same way, the change unit 16 may change a work label of the similar work history (stored in the third storage unit 17), in order for the user to easily discriminate the work label for retrieval.

For example, when the generation unit 15 assigns a work label to a work history “4” in FIG. 4, by referring to the third storage unit 17, the change unit 16 detects a similar work history having at least one work label common to “A-plan” or “investigation” among other work histories (“1”, “2”, “3” in FIG. 4). In this case, a work history “1” having common work label “investigation” is detected as the similar work history.

The change unit 16 may delete “investigation” common to work label of the similar work history “1” from work labels of the work history “4”. Alternatively, the change unit 16 may emphasize (For example, a bold typed display or colored display) “A-plan” not common to work labels of the similar work history “1” while being displayed hereafter. Furthermore, the change unit 16 may locate “A-plan” at the head position among work labels while being displayed hereafter.

The generation unit 15 writes the work history having the changed work label into the third storage unit 17, and the processing is completed. If the similar work history is not detected (No at S104), the change unit 16 completes the processing without change of work labels.

As mentioned-above, generation processing of the work history in the information processing apparatus 1 is already explained.

Moreover, the change unit 16 may be connected to the retrieval unit 18 and the third storage unit 17, and execute above-mentioned change processing by changing the similar work history when retrieval processing is executed. In this case, the generation unit 15 writes a work history to which all work labels (to be assigned) are assigned, into the third storage unit 17. When the retrieval unit 18 executes retrieval processing, the change unit 16 may execute the change processing, and display the work history on the display unit.

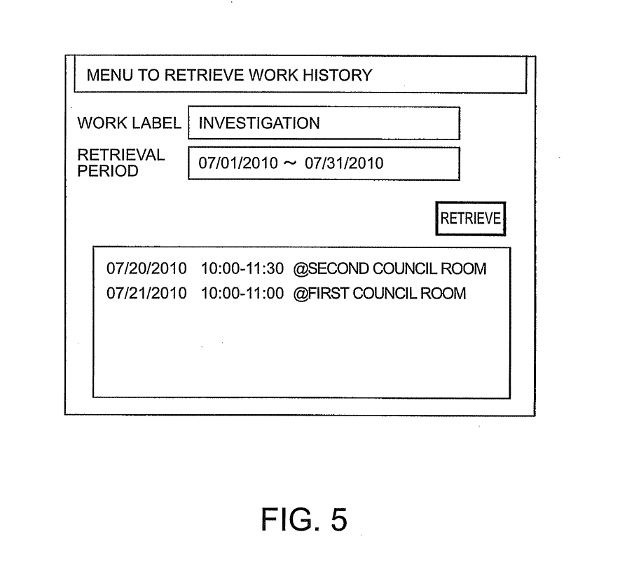

FIG. 5 is one example of application when the retrieval unit 18 executes retrieval processing. For example, from a user utilizing an input device (not shown in Fig.), the retrieval unit 18 accepts a retrieval request having a work label “investigation” and a retrieval period “Jul. 1, 2010-Jul. 31, 2010”. By referring to the third storage unit 17, the retrieval unit 18 retrieves a work history including the work label “investigation” in the retrieval period. In this case, two work histories “1” and “4” in FIG. 4 are corresponded.

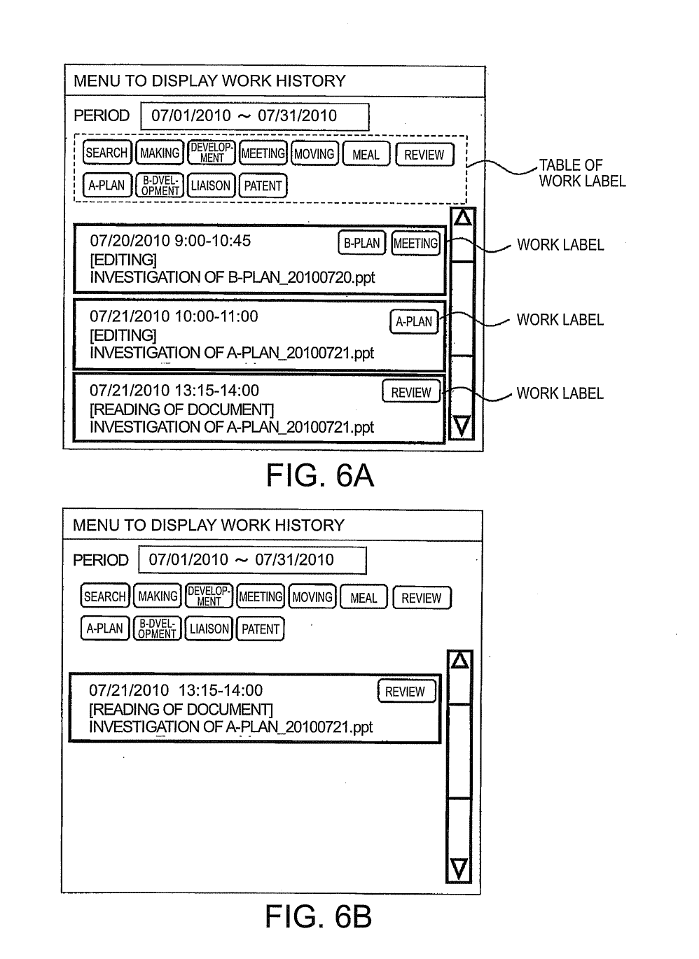

The retrieval unit 18 extracts two work histories “1” and “4” in FIG. 4, and displays them via the display unit 19. FIGS. 6A and 6B show examples of work history displayed on the display unit 19. As shown in FIG. 6A, the display unit 19 displays two work histories “1” and “4”. In this case, on the display unit 19, by above-mentioned processing (S104, S105) of the change unit 16, work labels “A-plan” and “B-plan” mutually uncommon are only displayed. However, by displaying all work labels, the display unit 19 may emphasize “A-plan” and “B-plan”. Alternatively, the display unit 19 may respectively locate “A-plan” and “B-plan” at the head position among all work labels.

As to the first embodiment, when a user repeatedly performs similar working with respective resource, if the respective resource includes different text information, a work label representing different feature of the text information can be generated. Accordingly, a work history (related to the respective resource) for the user to easily understand can be generated.

Furthermore, as shown in FIGS. 6A and 6B, the work label is used as a tag, and a table of user's work (work labels) is displayed. By selecting at least one work label from the table of work labels or the work history, the user can confirm a history of the user's working matched with the work label selected. For example, when the user selects a work label “review” in FIG. 6A, a work history including “review” is only displayed as shown in FIG. 6B. In this way, the work history represented by a specific work label can be retrieved or selected.

### The Second Embodiment

In an information processing apparatus 2 according to the second embodiment, a work label can be generated from not the text information but the user status acquired. This feature is different from the information processing apparatus 1 of the first embodiment.

In the information processing apparatus 1, if text information matched with date and time of occurrence of the user status is not stored in the second storage unit 14, as shown in a work history “2” of FIG. 4, work labels to be assigned thereto does not exist.

On the other hand, in the information processing apparatus 2, by using a past user status and text information corresponding to data and time information of occurrence of the past user status, “assignment rule” to determine a work label (to be assigned) from a present user status is trained, and a work history to which the work label is assigned is generated based on the assignment rule.

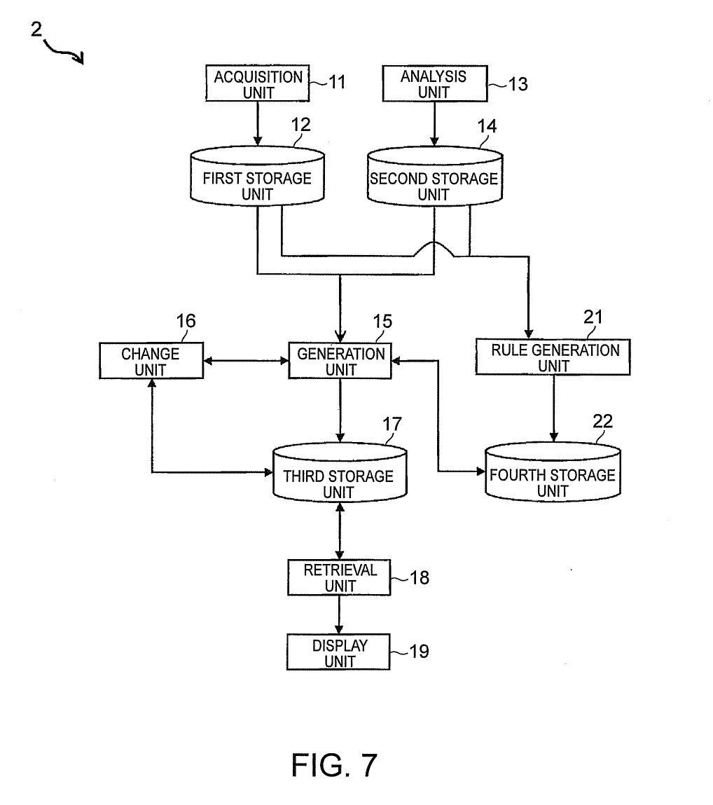

FIG. 7 is a block diagram of the information processing apparatus 2. In comparison with the information processing apparatus 1, the information processing apparatus 2 further includes a rule generation unit 21 and a fourth storage unit 22. Furthermore, the generation unit 15 generates a work label by using the assignment rule, which is different from the first embodiment.

From a user status acquired by the acquisition unit 11 and text information acquired by the analysis unit 13, the rule generation unit 21 generates “assignment rule” to correspond the user status with a work label. In the same way as the first embodiment, the rule generation unit 21 extracts work labels from the text information by using morphological analysis or built-in rule. By setting the work label to “classified class” and the user status thereof to “attribute”, the rule generation unit 21 determines the assignment rule. Detail processing is explained afterwards.

The fourth storage unit 22 stores the assignment rule generated by the rule generation unit 21. Moreover, the rule generation unit 21 may update the assignment rule based on text information acquired. Briefly, the rule generation unit 21 may prepare a function to train the assignment rule.

The generation unit 15 generates a work history to which a work label is assigned based on the assignment rule stored in the fourth storage unit 22, in addition to processing thereof in the first embodiment.

The rule generation unit 21 may be realized by a central processing unit (CPU) and a memory used thereby. The fourth storage unit 22 may be realized by the memory or an auxiliary storage device.

As mentioned-above, component of the information processing apparatus 2 (mainly, a feature different from the information processing apparatus 1) is already explained.

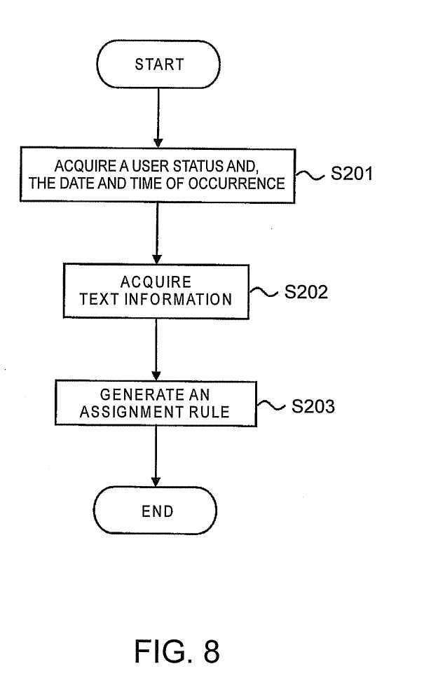

FIG. 8 is a flow chart of generation processing of the assignment rule by the information processing apparatus 2. The acquisition unit 11 acquires a user status and data and time of occurrence (S201). This step may be same as S201 in FIG. 2. The acquisition unit 11 writes the user status and the date and time of occurrence into the first storage unit 12.

The analysis unit 13 analyzes resources used by a user, and acquires text information included in the resources (S102). This step may be same as S102 in FIG. 2. The analysis unit 13 writes the text information into the second storage unit 14.

The rule generation unit 21 extracts a work label from the text information stored in the second storage unit 14, and generates an assignment rule (S203). For example, if text information acquired by the analysis unit 13 includes information of 5W1H (who, when, where, which, what, how), such as text information “investigation of A-plan_{—}20100721.ppt” including “contents (invitation of A-plan)” and “date and time (20100721)”, the generation unit 15 segments the text information by using morphological analysis or built-in rule, and extracts text information such as “A-plan” and “investigation” as a work label.

In this case, the rule generation unit 21 uses text information related to place, date and time (such as “20100721” simultaneously extracted) as an attribute to generate the assignment rule. The generation unit 15 writes the assignment rule into the fourth storage unit 22, and the processing is completed.

Next, generation processing of assignment rule by the rule assignment unit 21 is explained in detail. In this case, an example that the assignment rule is generated by using a decision tree is explained. The rule generation unit 21 may generate a decision tree by using C4.5 algorithm well as conventional technique. Briefly, based on training data including classified class and attribute, the rule generation unit 21 composes the decision tree so as to maximize a bias (gain) of information quantity.

As the classified class, a work label extracted from text information stored in the second storage unit 14 is used. As the attribute, a user status occurred at date and time corresponding to the work label, and place, date and time information extracted from the text information, are used.

In the example at 10:00˜11:00 in FIG. 3, a work label “A-plan” is used as a classified class, a user status (a moving status “standstill”, a wireless AP “A, B, C”, a proximity status “a, b, c, d”, an operation status “editing”) corresponding to date and time of the work label “A-plan”, a start time “10:00” and a duration “one hour”, are used as an attribute. By using the classified class and the attribute, a decision tree is trained.

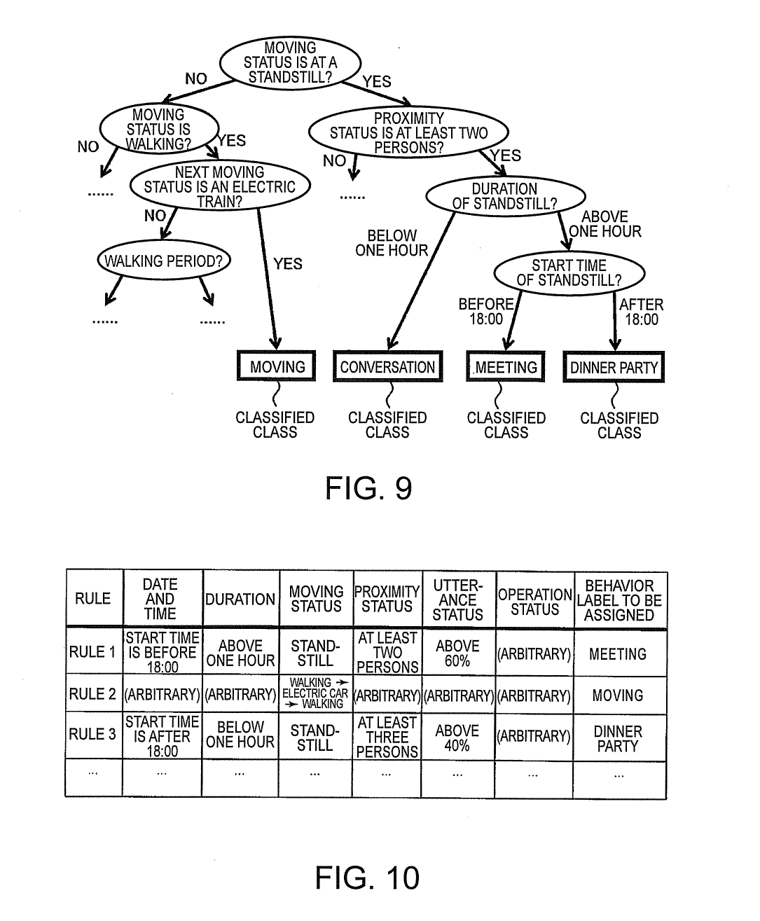

FIG. 9 is one example of the decision tree generated by the rule generation unit 21. As shown in FIG. 9, based on an answer to a question at each node, the rule generation unit 21 trains the decision tree to trace a classified class at each leaf. Except for the decision tree, as shown in FIG. 10, the rule generation unit 21 may generate a rule table having a matching pattern to trace a branch of the decision tree, as the assignment rule.

Moreover, as the attribute used for training of the decision tree, not only a status occurred at date and time corresponding to the work label but also a status in a period having a predetermined time segment (For example, fifteen minutes) before and after the occurred time, may be used. Furthermore, in the second embodiment, the decision tree is trained as the assignment rule (discriminator). However, the decision tree is not limited to this one if the decision tree is trained by using the classified class and the attribute thereof. For example, the assignment rule may be trained by SVM (Support Vector Machine) as the discriminator. Furthermore, a classified class having quantity of training data above a predetermined threshold may be used for training.

Furthermore, the rule generation unit 21 may statistically extract work labels from text information stored in the second storage unit 14. For example, by regarding text information as a document, the rule generation unit 21 may classify the document, and select a word frequently occurred in each classification as the work label.

As one example thereof, in conventional technique “Latent Dirichlet Allocation (LDA)”, assume that each document includes potential topic, and each potential topic has a distribution of occurrence probability of word. As to a set of text information stored in the second storage unit 14, the rule generation unit 21 estimates a potential topic by applying LDA, and selects a word frequently occurred in the estimated potential topic, as the work label. In this case, the word selected by the rule generation unit 21 may be, for example, each morpheme of morphological analysis result or a proper noun.

Moreover, the rule generation unit 21 may select not one word but a compound word having a plurality of words, as the work label. For example, the rule generation unit can utilize “C-value” method disclosed in “K. Frantsi and S. Ananiadou, Extracting Nested Collocations, in Proceedings of COLING-96, pp. 41-46, 1996”. In this case, among words having high “C-value”, the rule generation unit 21 may select the compound word including a feature word of each topic by “LDA”, as the work label.

Furthermore, the rule generation unit 21 may estimate the topic by clustering. As the clustering method, conventional technique such as “k-means method” or “categorical clustering” may be used. The rule generation unit 21 may regard each cluster acquired by this method as a topic, and extract a feature word from occurrence information of word included in each cluster.

As mentioned-above, generation processing of the assignment rule by the rule generation unit 21 is already explained.

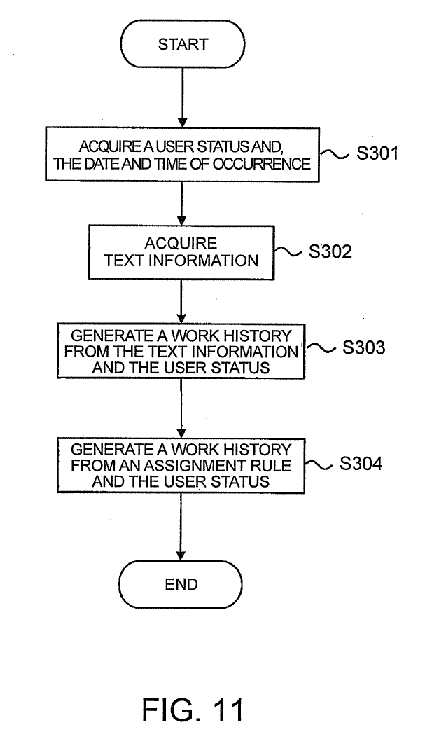

FIG. 11 is a flow chart of assignment processing of work label in the information processing apparatus 2. The acquisition unit 11 correspondingly acquires a user status and the data and time information of occurrence (S301). This step may be same as S101 in FIG. 2. The acquisition unit 11 writes the user status into the first storage unit 12.

The analysis unit 13 analyzes resources used by a user, and acquires text information included in the resources (S302). This step may be same as S102 in FIG. 2. The analysis unit 13 writes the text information into the second storage unit 14.

By using the user status extracted from the first storage unit 12 and the text information extracted from the second storage unit 14, the generation unit 15 generates a work label and a work history to which the work label is assigned (S303). This step may be same as S103 in FIG. 2.

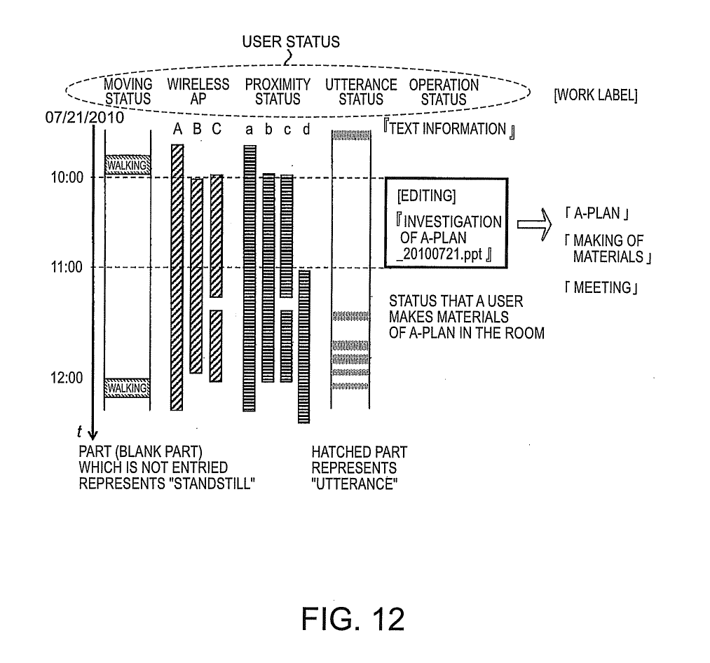

By using the assignment rule stored in the fourth storage unit 22 and the user status stored in the first storage unit 12, the generation unit 15 assigns the work label (S304), and the processing is completed. FIG. 12 is a schematic diagram to explain assignment processing of the work label. In the second embodiment, the generation unit 15 utilizes a decision tree shown in FIG. 9 as the assignment rule, or a rule table shown in FIG. 10.

If the decision tree of FIG. 9 is utilized, by using a user status occurred in a period to which the work label is not assigned, and date and time of occurrence thereof, the generation unit 15 answers to a question (“moving status is at a standstill?”) at a head node of the decision tree.

The generation unit 15 further answers to a question at a node located by tracing a branch corresponding to the previous answer. Then, the generation unit 15 traces a branch by answering to a question at each node until reaching a leaf of the decision tree. Last, when the leaf is reached, the generation unit 15 sets a classified class stored at the leaf to a work label corresponding to date and time thereof, and assigns the work label to a work history corresponding to the date and time.

In an example at 10:00˜11:00 of FIG. 12, an answer to “moving status is at a standstill?” is “yes” by the decision tree in FIG. 9. An answer to “proximity status is at least two persons?” is “yes”. An answer to “duration of standstill?” is “above one hour”. An answer to “start time of standstill?” is “before 18:00”. Accordingly, the generation unit 15 assigns a work label “meeting” to a work history corresponding to a period “10:00˜11:00”.

Moreover, in FIG. 10, even if not all conditions but a part of the conditions is satisfied, the generation unit 15 may assign a work label of the rule. If a plurality of rules is satisfied at the same time, a plurality of work labels corresponding to the plurality of rules is assigned. In this case, the generation unit 15 may set a priority to each rule based on training data quantity of each classified class used for training, and preferentially select a work label of the rule having high priority.

Furthermore, the generation unit 15 may segment date and time to assign a work label by a specific period. For example, as to a period segmented every one hour (such as “10:00˜11:00”, “11:00˜12:00”) , the generation unit 15 may assign the work label. Except for this, the generation unit 15 may assign the work label to date and time in which the same status continues over a predetermined period. For example, if the same moving status continues over thirty minutes, the generation unit 15 may assign the work label.

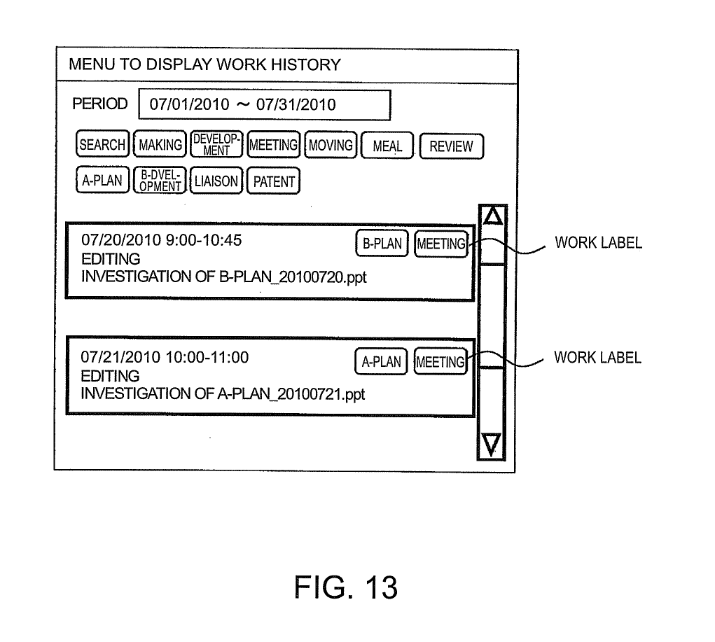

FIG. 13 is one example of a work history displayed on the display unit 19. By above-mentioned processing, in comparison with FIG. 6, “meeting” is added to a work label of the work history “investigation of A-plan_{—}20100721.ppt”.

According to the second embodiment, except for processing of the first embodiment, by using above-mentioned assignment rule, a work history to which a work label is assigned is generated. As a result, even if text information from which a work label is selected does not exist, the work label can be assigned.

Moreover, in the second embodiment, as to date and time corresponding to text information (stored in the second storage unit 14) unable to extract a work label, the work label can be assigned. As a result, a user can retrieve a work history related to text information registered in an incomplete status that the work label cannot be extracted.

### Modification 1

In the second embodiment, the assignment rule is trained by using text information and user status of one user. However, the assignment rule may be trained by using text information and user status of a plurality of users. As a result, in modification 1, training data quantity to train the assignment rule can be increased.

Furthermore, by acquiring identification information of adjacent user as a user status, the assignment rule can be also trained by using the user status as an attribute. As a result, the assignment rule can be trained based on a specific user's participation status, for example, a work label of a meeting is “report meeting” if the specific user participates in the meeting, and the work label is “investigation meeting” if the specific user does not participates.

### Modification 2

The analysis unit 13 may acquire text information described by a communication meeting with a text, such as a chat or a micro-blog. For example, a user often sends a message “Now, in meeting” during meeting, or writes “Just before, I suddenly met Mr. T and talked with him.” into a micro-blog after the user stood talking. From this text information, the rule generation unit 21 may train the assignment rule.

For example, when a user wrote “Just before, I talked with Mr. Tanaka.” into a micro-blog after the user stood talking, the analysis unit 13 acquires a text written into the micro-blog by the user and date and time of sending thereof as text information, and stores them into the second storage unit 14. Then, the rule generation unit 21 analyzes the text information stored in the second storage unit 14, and extracts a work label and the date and time information. As to the date and time information, the rule generation unit 21 converts an expression in the text to the date and time information similar to a schedule, such as “just before→five minutes before” or “this morning→9 AM˜12 AM in the same day”. As to the work label, the rule generation unit 21 extracts a vocabulary representing behavior such as “stand talking”, “meeting” or “concert”. As a result, if a text “Just before, I talked with Mr. Tanaka.” is sent at “12:30, Dec. 14, 2010”, the same processing as the case that a schedule “stand talking at 12:25, Dec. 14, 2010” is previously registered can be executed. Moreover, the rule generation unit 21 may utilize the extracted date and time information “12:25, Dec. 14, 2010” as an attribute to train the assignment rule.

### Modification 3

The rule generation unit 21 may decide a synonym among a plurality of work labels, and train the assignment rule by using a work label of the synonym as the same classified class. For example, the rule generation unit 21 decides two work labels “arrangement” and “arrange” as a synonym, and trains the assignment rule by using the unified work label “arrangement” as the classified class. In this case, in order to decide whether work labels are synonym, a method for using notation thereof or a plurality of user status corresponding to the work labels, may be used.

A method for deciding a synonym by notation is explained. In this case, the rule generation unit 21 decides whether a plurality of work labels is a synonym by using similarity among texts of the plurality of work labels. For example, as to “arrangement” and “arrange”, their texts are similar and decided as a synonym. For example, similarity between texts may be decided by using nearness of editing distance. Furthermore, the synonym may be decided by inclusion relationship of notation among the plurality of work labels. For example, “development meeting” is a lower concept of “meeting”. This is decided because a text “development meeting” includes a text “meeting”. In this way, if a plurality of work labels has inclusion relationship, the rule generation unit 21 can unify the classified class to a higher concept “meeting”.

A method for deciding a synonym by a plurality of user status is explained. If a plurality of users performs the same behavior at the same time, work labels extracted from text information of each user are often different. In this case, the rule generation unit 21 decides each work label as the synonym. For example, assume that work labels extracted from text information of two persons who participated in the same meeting are different such as “meeting” and “conference”, and two terminals of the two persons mutually detect the other of the two terminals as proximity information. Behavior of the two persons can be decided as the same one. Furthermore, by using similarity between two statuses acquired from the two terminals, the same behavior of the two persons may be decided. In this case, work labels “meeting” and “conference” extracted from text information of two persons is decided as a synonym. As the classified class unified, a work label of which occurrence frequency is larger may be used.

In this way, when a plurality of work labels is decided as a synonym, the assignment rule is trained by the plurality of work labels as the same classified class. As a result, it is prevented that work labels (synonym) having different notation are assigned to the date and time to originally assign the same work label. Furthermore, by unifying classified classes to one class, training data quantity of the one class can be increased.

### Modification 4

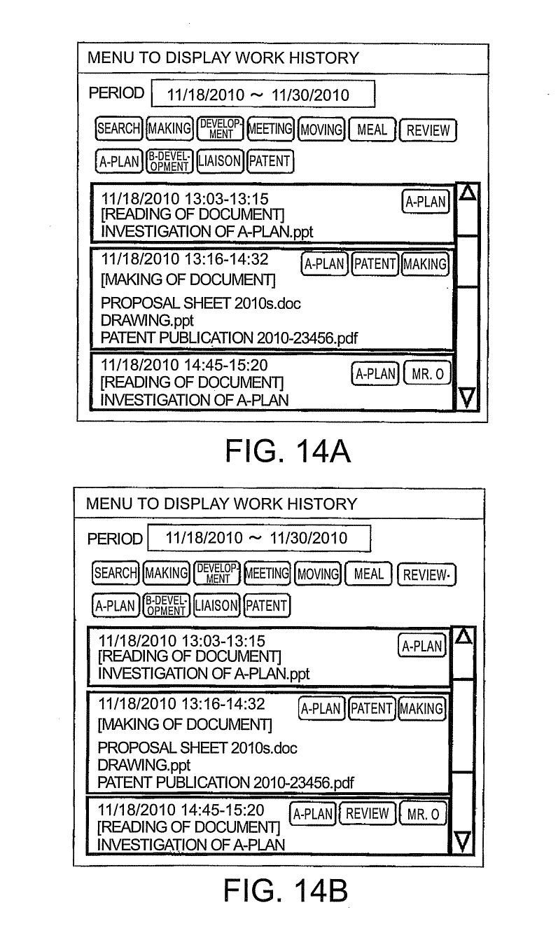

The rule generation unit 21 may generate an assignment rule by using a work label inputted from a user, except for acquiring the work label from text information stored in the second storage unit 14. In this case, the information processing apparatus 2 includes a registration unit (not shown in Fig.) to write the work label (inputted from the user) into the fourth storage unit 22. For example, in a menu to display work history shown in FIGS. 14A and 14B, assume that work labels (“A-plan” and “review” in FIG. 14A) are selectively inputted by the user. The registration unit (not shown in Fig.) registers the work labels into the fourth storage unit 22. By using the work labels registered, the rule generation unit 21 updates the assignment rule. As a result, as shown in a work history of FIG. 14B, the work history is updated by assigning work labels “A-plan” and “review”.

### Modification 5

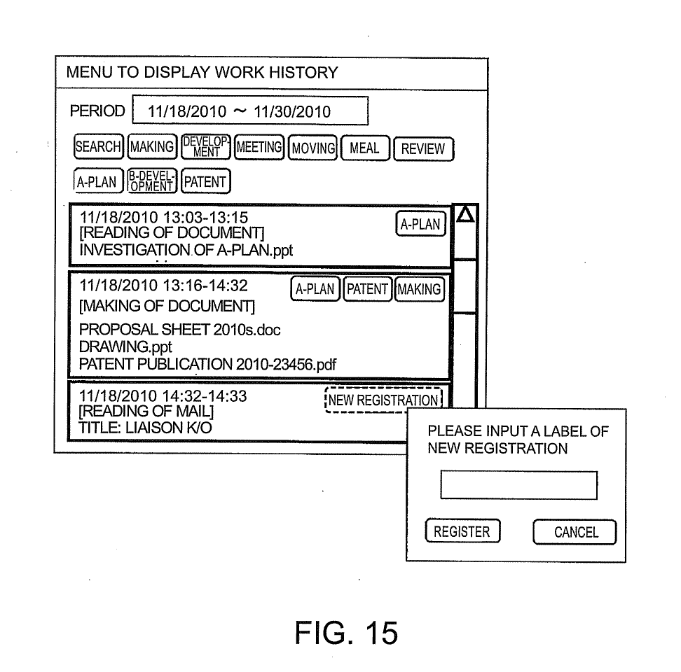

Furthermore, in the menu to display work history shown in FIGS. 14A and 14B, as to behavior corresponding to time segment to which the work label is not assigned by the generation unit 15, the registration unit (not shown in Fig.) may be urged to be used. FIG. 15 is one example of a screen to urge to register a work label. As to a work history to which the work label is not assigned, the display unit 19 displays a button “new registration”. When the user selects the button, a registration form is displayed. When the user inputs a work label, the registration unit (not shown in Fig.) registers the work label.

### Modification 6

Among a plurality of businesses previously determined, if some time segment which a user has worked is to be classified into any business, by previously defining a work label of each business, it may be decided whether the user's behavior is classified to any work label.

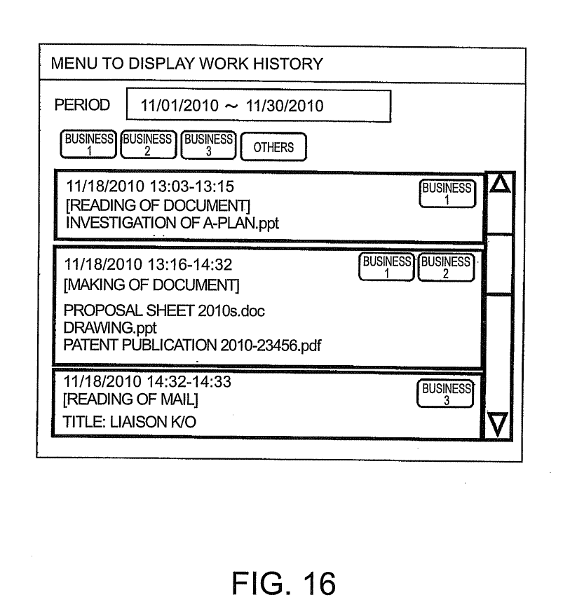

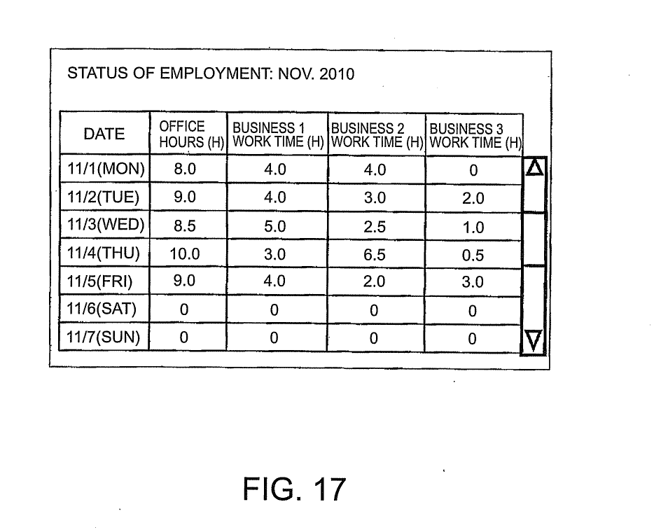

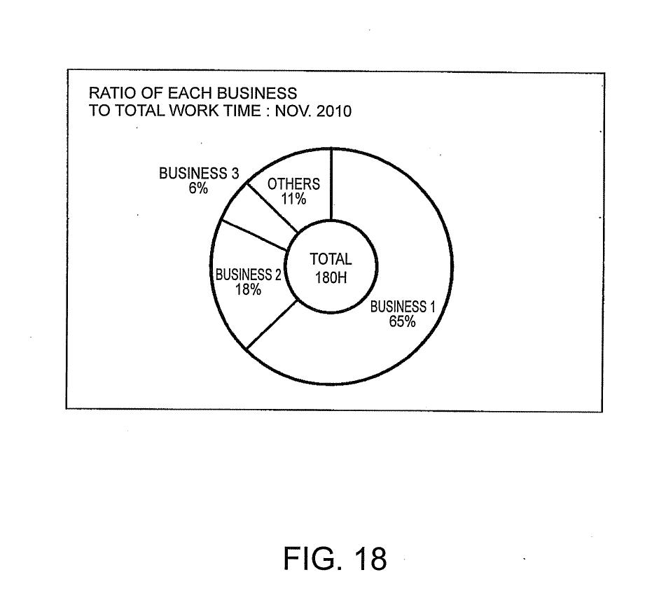

For example, if three businesses “business 1”, “business 2” and “business 3” exist, as shown in FIG. 16, the display unit 16 displays the three businesses as three work labels. If some behavior to which none of the three work labels is assigned exists, a work label “others” may be assigned thereto. By classifying the user's behavior into any work label, among work histories stored in the third storage unit 17, a period of behavior to which a specific work label is assigned can be summed up. As a result, as shown in FIG. 17, the user's behavior can be subjected to man-hour control. In FIG. 16, as a second behavior that two work labels “business 1” and “business 2” are assigned, if a plurality of work labels is assigned to one behavior, by regarding that the user has worked for both businesses in a predetermined ratio, the generation unit 15 may assign either of two labels to this behavior. Alternatively, only one work label may be assigned to one behavior. Moreover, the display unit 19 may display not a format of man-hour control in FIG. 16 but a ratio of each business to total work time in FIG. 18.

### Modification 7

Based on a user' s operation, the retrieval unit 18 may update a priority to display each work label. For example, if the user often utilizes selection by pushing a button of specific work label, the retrieval unit 18 may display the specific work label at the head position or emphasized format.

### Modification 8

In the second embodiment, one decision tree is trained as the assignment rule. However, the rule generation unit 21 may generate the assignment rule as a plurality of decision trees or by using another discriminator. For example, at date and time to which a work label “meeting” is assigned, the rule generation unit 21 may assign work labels (such as “development meeting”, “group meeting”) to classify the meeting in detail by using another decision tree.

According to above-mentioned embodiments, the work history related to resources can be generated for a user to easily understand.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for processing information, comprising:
an acquisition unit configured to acquire a status of a user while the user is working with a resource;
an analysis unit configured to acquire text information included in the resource by analyzing the resource; and
a generation unit configured to generate at least one work label from the status of the user and the text information, and to generate a work history including a part of the text information, to which the work label is assigned.

2. The apparatus according to claim 1, further comprising:
a change unit configured to, when a plurality of work histories having the same work label is detected, change the same work label of at least one of the work histories to a work label different from work labels of the work histories except for the at least one.

3. The apparatus according to claim 2, further comprising:
a rule generation unit configured to generate an assignment rule to correspond the status with the work label from the status and the text information, and
wherein the generation unit generates the work history to which the work label is assigned, based on the assignment rule.

4. The apparatus according to claim 3,
wherein the acquisition unit acquires a moving status, a proximity status or an utterance status of the user, while the user is working with the resource.

5. A method for processing information, comprising:
acquiring a status of a user while the user is working with a resource;
acquiring text information included in the resource by analyzing the resource;
generating at least one work label from the status of the user and the text information; and
generating a work history including a part of the text information, to which the work label is assigned.
